(19) United States
(12) Patent Application Publication
(10) Pub. No.: US 2011/0044043 A1
(43) Pub. Date: Feb. 24, 2011

(54) LED LAMP

(76) Inventor: Shwin-Chung WONG, Hsinchu (TW)

Correspondence Address: Muncy, Geissler, Olds & Lowe, PLLC, 4000 Legato Road, Suite 310, FAIRFAX, VA, 22033, US

(21) Appl. No.: 12/640,631

(22) Filed: Dec. 17, 2009

(30) Foreign Application Priority Data
Aug. 21, 2009 (TW) 98128179

(51) Int. Cl. F21S 4/00

(52) U.S. Cl. 362/249.02

(57) ABSTRACT

An LED lamp includes at least a flat-plate heat pipe arranged within a flat sealing container, wherein the upper and the lower surfaces of the flat-plate heat pipe respectively contact with the internal walls of the top plate and the base plate of the sealing container. At least one LED module is configured on the base plate. The heat generated by the LED module transfers through the base plate to the flat-plate heat pipe, and vaporizes the working fluid therein, so that the heat is spread with the vapor motion, and is then released to the atmosphere through the large area including the external wall of the sealing container and the fin structure thereon. The sealing container provides structural strength of the lamp and protects the flat-plate heat pipe from corrosion by water and contaminants in the environment.

### BACKGROUND OF THE INVENTION

1. Field of the Invention

The present invention relates to an LED (Light Emitting Diode) lamp, particularly to an LED lamp using flat-plate heat pipes to dissipate the heat generated by the LEDs.

2. Description of the Prior Art

When the high-power LEDs (Light Emitting Diode) irradiate, a large amount of heat may be generated. If the heat is not dissipated effectively, the LEDs become heated, thereby affecting their performance and life time. It is therefore crucial to provide a good heat dissipation mechanism for an LED lamp. Active dissipation using a fan leads to high dissipation effectiveness, but the noise and the limited life time of the fan would be a concern. When the heat of the LEDs is dissipated by passive natural convection, the LED lamp is free from noise and breakdown of the fan.

For passive heat-dissipation, materials of high thermal conductivity, such as copper, aluminum, and so on, may be adopted as the heat dissipating medium. However, as far as high-power LEDs are concerned, the heat dissipation capability of these materials are usually insufficient. Hence, highly conductive tubular heat pipes or flat-plate heat pipes are employed for effective heat spreading to a larger area required for passive heat dissipation. However, most high-performance heat pipes are fabricated with copper. Corrosion of the copper heat pipes by water and contaminants from the environment would occur if they are not fully protected. The LED lamp can be damaged once the heat pipes break down.

### SUMMARY OF THE INVENTION

The present invention discloses an LED lamp containing highly conductive flat-plate heat pipes embedded in a flat sealing container. The embedded flat-plate heat pipes effectively spread the heat from the LEDs to the large area of the sealing container surfaces and the heat can be dissipated to the atmosphere via a fin structure on the outer surfaces of the container.

In addition, the sealing container of the LED lamp can fully protect the flat-plate heat pipes from corrosion by water and contaminants from the environment. Furthermore, the sealing container can provide sufficient structural strength of the LED lamp assembly.

According to one embodiment of the present invention, an LED lamp includes a sealing container, at least one flat-plate heat pipe, and at least one LED module. An enclosure is formed with the internal wall of a base plate, the internal wall of a top plate, and the internal walls of the sides, and at least one LED module mounting section is defined on the base plate. The flat-plate heat pipe, embedded in the enclosure, has an upper surface and a lower surface respectively contacting with the internal wall of the top plate and the internal wall of the base plate. The LED module includes a substrate and at least one LED device mounted thereon, with the other side of the substrate attached to the external wall of the LED module mounting section of the base plate.

Other advantages of the present invention will become apparent from the following descriptions with the accompanying drawings for certain embodiments of the present invention.

### BRIEF DESCRIPTION OF THE DRAWINGS

FIG. 1 is a structure diagram schematically illustrating an LED lamp according to an embodiment of the present invention;

FIG. 2 is a partial structure diagram schematically illustrating an LED lamp according to an embodiment of the present invention;

FIG. 3 is a partial structure diagram schematically illustrating an LED lamp according to an embodiment of the present invention;

FIG. 4 is a partial top view diagram schematically illustrating an LED lamp according to another embodiment of the present invention; and

FIG. 5 is a structure diagram schematically illustrating an LED lamp according to another embodiment of the present invention.

### DESCRIPTION OF THE PREFERRED EMBODIMENT

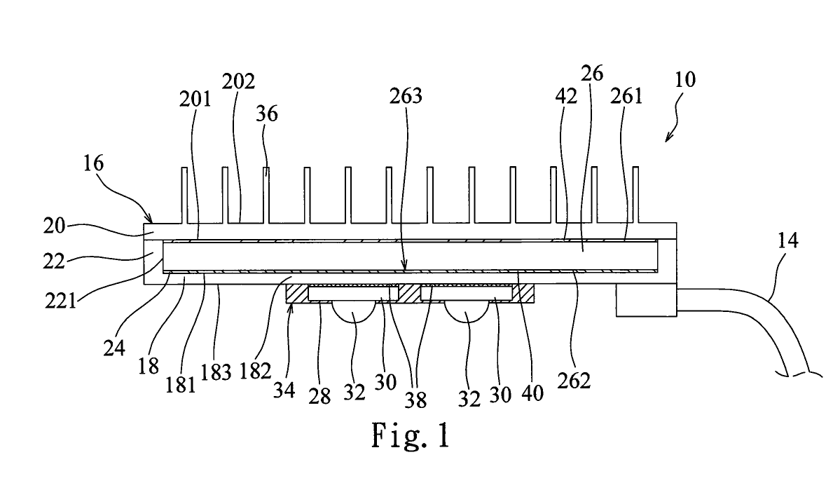

FIG. 1 schematically illustrates the structure of an LED lamp according to an embodiment of the present invention. An LED lamp 10 includes a sealing container 16, a plurality of flat-plate heat pipes 26 and a plurality of LED modules 28. The sealing container 16, mounted to one end of a lamp post 14, has a base plate 18, a top plate 20 and four sides 22. An enclosure 24 is formed with the internal wall 181 of the base plate 18, the internal wall 201 of the top plate 20, and the internal walls 221 of the sides 22. To form the sealing container 16, the base plate 18, top plate 20 and sides 22 can be connected to each other by partial integration (for example, the base plate 18 and the sides 22 can be made in an integral unit), soldering, adhesive bonding, or screwing. The top plate 20, the base plate 18 and the sides can be made of different materials. An LED module mounting section 182 is defined on the base plate 18. Each of the flat-plate heat pipes 26 is arranged within the enclosure 24 and has an upper surface 261 and a lower surface 262 respectively contacting with the internal wall 201 of the top plate 20 and the internal wall 181 of the base plate 18. Each of the LED modules 28 has a substrate 30 and an LED device 32 electrically connected to the power source (not shown). The substrate 30 is attached to an external wall 183 of the LED module mounting section 182 of the base plate 18. A sealing material 34 or a sealing cover may be arranged around the contact interfaces between the LED modules 28 and the base plate 18 to prevent moisture or other contaminants from entering the interfaces. In addition, a heat dissipating fin structure 36 may be configured on the external wall 202 of the top plate 20. The external wall 202 of the top plate 20, the external surface of the heat dissipating fin structure 36, the external wall 183 of the base plate 18, and the external surfaces of the sides may be specially treated, for example, with anodization, painting or coating, to increase the radiative emissivity of the external surfaces and hence the radiative heat dissipation.

In FIG. 1, a first interface material 38 may be arranged between the substrate 30 of the LED modules 28 and the external wall 183 of the base plate 18; a second interface material 40 arranged at least between the internal wall 181 of the LED module mounting section 182 of the base plate 18 and the evaporation zone on the lower surface 262 of the flat-plate heat pipe 26; and a third interface material 42 arranged between the upper surface 261 of the flat-plate heat pipe 26 and the internal wall 201 of the top plate 20. The first interface material 38, second interface material 40 and third interface material 42, such as solder, thermal pad, thermal grease, thermal paste, or thermal tape, etc., are used to reduce the thermal contact resistances therebetween.

The flat-plate heat pipe 26 is a sealed thin cavity having a small amount of working fluid (not illustrated) and at least a layer of capillary structure (not illustrated) bonded to its internal wall. The evaporation zone 263 of the flat-plate heat pipe 26 refers to the area where the working fluid therein is vaporized by the heat from the source to be cooled. The other area of the flat-plate heat pipe 26 can be used as the condensation zone. The heat generated by the operating LED devices 32, transferring through the substrate 30 and the base plate 18 of the sealing container 16 to the evaporation zone 263 of the flat-plate heat pipe 26, vaporizes the working fluid in the evaporation zone 263. The heat-carrying vapor spreads all over the cavity and condenses on the large area of the condensation zone. The heat is then released to the atmosphere through the large area including the external wall of the sealing container 16 and the fin structure 36 thereon.

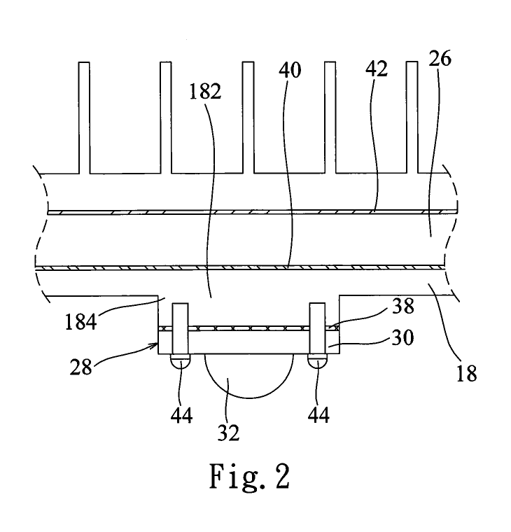

The sealing container 16 may be in any shape, such as a flat plate or a curved plate, having a rectangular or non-rectangular footprint shape. The top plate 20 of the sealing container 16 and the fin structure 36 may be in an integral unit or assembled according to different designs. The substrate 30 of the LED modules 28 may be fixed to the base plate 18 of the sealing container 16 by soldering or screwing. As in the embodiment illustrated in FIG. 2, a protrusion 184 is provided at the LED module mounting section 182 of the base plate 18 while other sections of the base plate 18 may be very thin for weight reduction. Thus, the LED modules 28 can be fixed firmly to the base plate 18 using screws 44. There may also be a first interface material 38 between the protrusion 184 and the substrate 30 of the LED modules 28 to reduce the contact resistance.

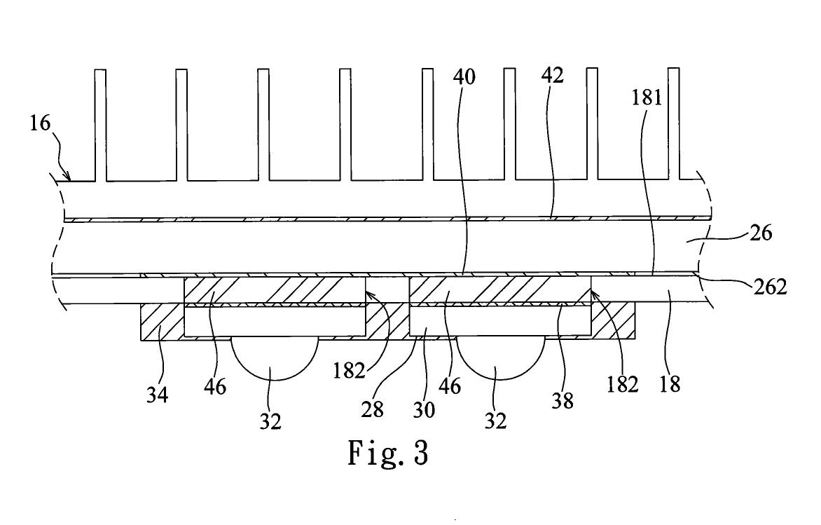

Another embodiment, as illustrated in FIG. 3, contains a plurality of thermal vias 46 at the LED module mounting section 182 of the base plate 18. This embodiment is especially useful when the material of the base plate 18 is less conductive or has lower solderability, such as aluminum or other metals and nonmetals. A preferred material for the thermal vias 46 is copper, which is highly conductive and solderable. Each of the thermal vias 46 provides a surface for good solderability with the substrate 30 of the LED modules 28 and with the lower surface 262 of the flat-plate heat pipe 26. If the interfaces between the thermal vias 46 and the substrate 30 of the LED modules 28, or the interfaces between the thermal vias 46 and the lower surface 262 of the flat-plate heat pipe 26, are not soldered, other thermal interface materials, such as thermal paste, thermal pad, thermal tape, etc. may be used as the first interface material 38 or the second interface material 40. Outside the thermal vias 46, the internal wall 181 of the base plate 18 may contact with the lower surface 262 of the flat-plate heat pipe 26 by way of a thin layer of solder or other thermal interface materials to reduce the thermal contact resistance therebetween.

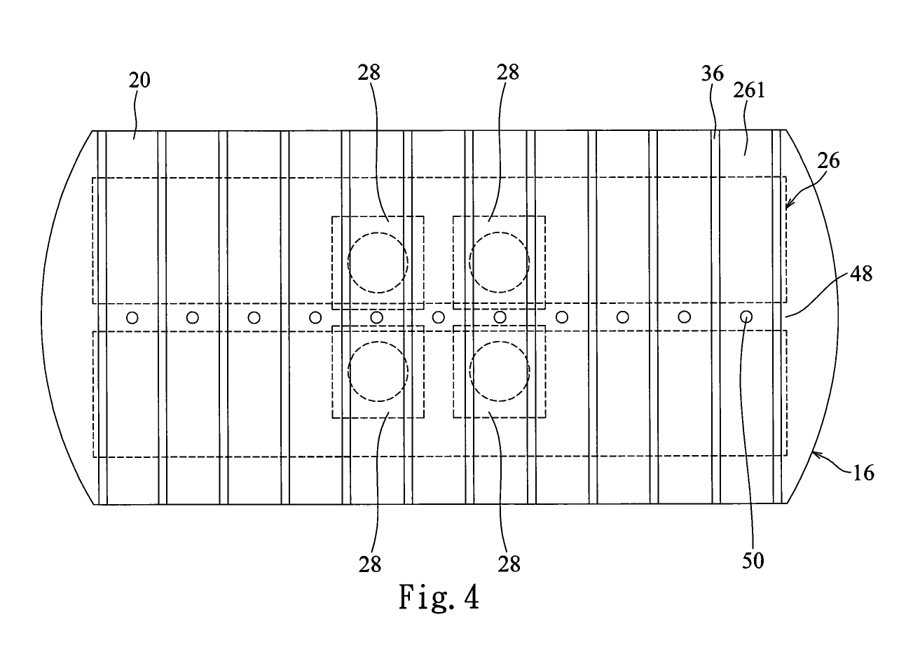

FIG. 4 is a partial top view diagram illustrating an LED lamp according to another embodiment of the present invention. As illustrated, four sets of LED modules 28 are arranged on the base plate 18 of the sealing container 16 (as illustrated in FIG. 1). In this embodiment, a spacer 48 is arranged in the enclosure 24 defined in FIG. 1. The top end of the spacer 48 is set on the internal wall 201 of the top plate 20, and the bottom end of the spacer 48 is set on the internal wall 181 of the base plate 18. The enclosure 24 is thus divided into two partitions, with one flat-plate heat pipe 26 arranged within each partition. The spacer 48 and the base plate 18 can be in an integral unit. A thermal interface material can be disposed between internal surfaces of the sealing container 16 and the external surfaces of the flat-plate heat pipes 26. Again, a heat dissipating fin structure 36 can be configured on the external wall 202 of the top plate 20 of the sealing container 16. Furthermore, a plurality of through holes 50 can be configured on the spacer 48 and between the fins of the heat dissipating fin structure 36. The through holes 50 penetrate the top plate 20, the spacer 48 and the base plate 18 so that cold air below the lamp may flow upward via the through holes 50 and the space between the fins of the heat dissipating fin structure 36 to enhance heat dissipation. In practice, more partitions with more flat-plate heat pipes 26 can be arranged. For example, in the embodiment shown in FIG. 4 there can be four partitions, each containing one shorter flat-plate heat pipe 26 to handle one set of LED modules 28. Also, there can be more than four sets of LED modules 28.

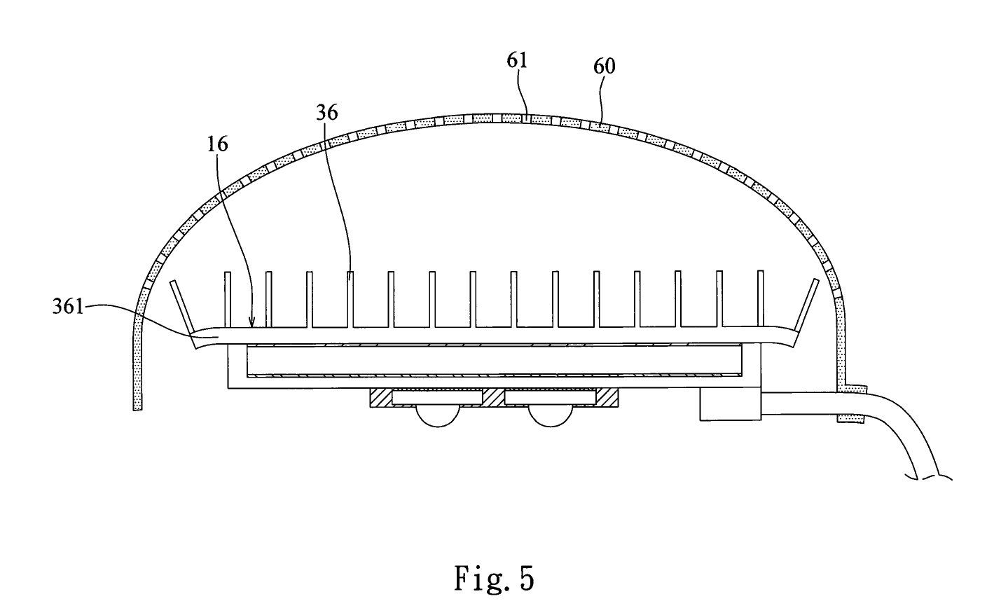

FIG. 5 is a structure diagram illustrating an LED lamp according to another embodiment of the present invention. In comparison with the structure illustrated in FIG. 1, this structure further includes a lampshade 60 with multiple air vents 61 for upward air flow. Also, the heat dissipating fin structure 36 illustrated in FIG. 5 contains an extension 361 out of the sealing container 16 for further extended heat dissipation area.

In conclusion, the present invention provides an LED lamp with flat-plate heat pipes configured within a sealing container and a plurality of LED modules disposed on the external surface of the base plate of the sealing container. A thermal interface material is arranged at each interface along the heat flow route. Thus, the heat generated by high power LED modules is effectively spread through the flat-plate heat pipe to a large area of the sealing container. Preferably, a fin structure can be configured on the external wall of the sealing container to further enlarge the heat dissipating area. In addition, the sealing container not only provides sufficient strength of the LED lamp assembly but also provides full protection of the flat-plate heat pipes from corrosion by water and contaminants in the environment.

While the invention can be subject to various modifications and alternative forms, specific examples thereof has been shown in the drawings and have been described in detail. It should be understood, however, that the invention is not to be limited to the particular form disclosed, but on the contrary, the invention is to cover all modifications, equivalents, and alternatives falling within the spirit and scope of the appended claims.

What is claimed is:

1. An LED lamp, comprising:
a sealing container including a base plate, a top plate and a plurality of sides, between which an enclosure is formed, wherein the base plate has at least one defined LED module mounting section;
at least one flat-plate heat pipe arranged within said enclosure and having an upper surface and a lower surface respectively contacting with the internal wall of said top plate and the internal wall of said base plate; and
at least one LED module including a substrate and at least one LED device, wherein the substrate is attached to the external wall of said LED module mounting section.

2. The LED lamp as in claim 1, further comprising a heat dissipating fin structure configured at least on the external wall of said top plate of said sealing container.

3. The LED lamp as in claim 2, wherein said heat dissipating fin structure includes an extension out of said sealing container.

4. The LED lamp as in claim 2, wherein the external wall of said sealing container and the external surfaces of said heat dissipating fin structure are treated to increase the radiative emissivity thereof.

5. The LED lamp as in claim 1, further comprising a first interface material arranged between said substrate and the external wall of said base plate.

6. The LED lamp as in claim 5, wherein said first interface material is selected from the group consisting of solder, thermal pad, thermal grease, thermal paste, and thermal tape.

7. The LED lamp as in claim 1, further comprising a second interface material arranged between a portion of the internal wall of said base plate and a portion of the lower surface of said flat-plate heat pipe.

8. The LED lamp as in claim 7, wherein said second interface material is selected from the group consisting of solder, thermal pad, thermal grease, thermal paste, and thermal tape.

9. The LED lamp as in claim 1, further comprising a third interface material arranged between the internal wall of said top plate and the upper surface of said flat-plate heat pipe.

10. The LED lamp as claimed in claim 9, wherein the third interface material is selected from the group consisting of solder, thermal pad, thermal grease, thermal paste, and thermal tape.

11. The LED lamp as in claim 1, wherein said LED module mounting section is thicker than other sections of said base plate.

12. The LED lamp as in claim 1, wherein said substrate is fixed to said base plate by soldering or screwing.

13. The LED lamp as in claim 1, further comprising a spacer arranged in said enclosure, wherein one end of the spacer is set on the internal wall of said top plate and the other end of the spacer is set on the internal wall of said base plate.

14. The LED lamp as in claim 13, wherein a plurality of through holes are configured to penetrate the said top plate, said spacer, and said base plate.

15. The LED lamp as in claim 1, wherein at least one thermally conductive via is configured in said LED module mounting section and is to be engaged with said substrate of said LED module.

16. The LED lamp as in claim 1, wherein said enclosure is formed within said base plate, said top plate and said plurality of sides of said sealing container by adhesive bonding, soldering, screwing, or being partially in an integral unit.

17. The LED lamp as in claim 1, wherein said sealing container is in a shape of a flat plate or a curved plate.

18. The LED lamp as in claim 1, further comprising a lamp post for mounting said sealing container at one end of said lamp post.

19. The LED lamp as in claim 1, further comprising a lampshade above said sealing container, and said lampshade comprising a plurality of air vents.

20. The LED lamp as in claim 1 further comprising a seal cover or a sealing material covering the interface between said base plate and said substrate of said LED module.
